(19) United States
(12) Patent Application Publication
(10) Pub. No.: US 2016/0358589 A1
(43) Pub. Date: Dec. 8, 2016

(54) ELECTRONIC APPARATUS AND DISPLAY PROCESSING METHOD

(71) Applicant: SEIKO EPSON CORPORATION, Tokyo (JP)

(72) Inventor: Kohei KAWASAKI, Matsumoto-shi (JP)

(73) Assignee: SEIKO EPSON CORPORATION, Tokyo (JP)

(21) Appl. No.: 15/172,108

(22) Filed: Jun. 2, 2016

(30) Foreign Application Priority Data
Jun. 2, 2015 (JP) 2015-111966

(51) Int. Cl. G09G 5/36; G01C 21/36; G09G 5/02; G01C 21/34; G06F 3/0482; G06F 3/0481

(52) U.S. Cl. CPC G09G 5/363; G06F 3/0482; G06F 3/04817; G09G 5/02; G01C 21/3407; G01C 21/3626; G09G 2320/0666; G09G 2354/00; G09G 2320/08; G09G 2320/10

(57) ABSTRACT

An electronic apparatus includes a display processor that displays a plurality of routes intended uses of which are specified by a user in different display aspects in accordance with the intended uses of the plurality of routes.

### CROSS-REFERENCE

This application claims priority to Japanese Patent Application No. 2015-111966, filed Jun. 2, 2015, the entirety of which is hereby incorporated by reference.

### BACKGROUND

1. Technical Field

The present invention relates to an electronic apparatus, a display processing method, and a program.

2. Related Art

In mountain climbing, a climber basically travels along a route planed in advance, but traveling along the planed route is forced to be abandoned in some cases depending on the body condition of the climber himself/herself or a climbing companion, weather, or other factors on the day of mountain climbing.

Many climbers therefore prepare a primary route (main route) from a start point to a goal point as well as other reserve routes (sub routes). Displaying these routes on a mobile terminal assists a climber in judging necessity of route change during mountain climbing.

JP-A-5-313572 proposes a navigation apparatus that displays a deformed chart that allows at-a-glance understanding of a route sequence in an arrangement corresponding to information on the actual position. The navigation apparatus is believed to allow a schematic overall travel route and positional relationship to be readily grasped.

However, since a plurality of climbing routes including sub routes may possibly be related to each other in a complicated manner, simply displaying the routes on the screen of a mobile terminal could undesirably make the routes difficult to understand. In particular, since the display screen of a mobile terminal has a limited space, the routes need to be somehow skillfully displayed.

### SUMMARY

An advantage of some aspects of the invention is to provide an electronic apparatus, a display processing method, and a program capable of displaying a plurality of routes specified by a user in a readily understandable manner.

The invention can be implemented as the following aspects or application examples.

### Application Example 1

An electronic apparatus according to this application example includes a display processor that displays a plurality of routes intended uses of which are specified by a user in different display aspects in accordance with the intended uses of the plurality of routes.

In general, in planning a plurality of routes in mountain climbing and other activities, the user has determined the intended use of each of the routes in advance in many cases. In view of the fact described above, configuring the display processor to display the routes in different display aspects in accordance with the intended uses specified by the user allows the user to readily distinguish the plurality of routes displayed on the electronic apparatus from one another.

### Application Example 2

The electronic apparatus according to the application example may further include a memory that memorizes, as information that the display processor refers to, information representing the intended uses of the plurality of routes, and information representing a relationship between the plurality of intended uses and the plurality of display aspects (information representing display aspects associated with the intended uses and further representing the type of display aspect in accordance with which a route of a certain intended use should be displayed).

The display processor can therefore handle the display aspects associated with the intended uses as pre-memorized information. The user can therefore recognize the intended use of each of the routes displayed on the electronic apparatus on the basis of the display aspect of the route.

### Application Example 3

In the electronic apparatus according to the application example, the plurality of routes may include at least one of a sub route that is a reserve route and an escape route that allows the user to escape from a main route that is a primary route, and the main route.

The user can therefore readily identify each of the routes displayed on the electronic apparatus as the main route or the sub route or can readily identify each of the displayed routes as the main route or the escape route.

### Application Example 4

In the electronic apparatus according to the application example, the sub route may be a route having a first point on the main route as a start point and a second point on the main route as a goal point.

The main route and the sub route, which share part of the points on the two routes, are considered to be difficult for the user to distinguish. However, since the display processor displays the main route and the sub route in display aspects different from each other, the user can readily identify each of the intended uses of the routes displayed on the electronic apparatus as main or sub on the basis of the display aspect of the route.

### Application Example 5

In the electronic apparatus according to the application example, the escape route may be a route having any of points on the main route as a start point and a point that is not on the main route as a goal point.

The main route and the escape route, which share part of the points on the two routes, are considered to be difficult for the user to distinguish. However, since the display processor displays the main route and the escape route in display aspects different from each other, the user can readily identify the intended use of each of the routes displayed on the electronic apparatus as main or escape on the basis of the display aspect of the route.

### Application Example 6

In the electronic apparatus according to the application example, the display processor may display the plurality of routes in different line colors or line types in accordance with the intended uses of the plurality of routes.

The display processor can therefore display the routes in different line colors or line types in accordance with the intended uses specified by the user. The user can therefore readily recognize the intended use of each of the routes displayed on the electronic apparatus on the basis of the line color or line type of the route.

### Application Example 7

In the electronic apparatus according to the application example, the display processor may further display a route being selected by the user and routes not being selected by the user in display aspects different from one another.

The user can therefore readily recognize whether or not each of the routes displayed on the electronic apparatus is being selected on the basis of the display aspect of the route.

### Application Example 8

In the electronic apparatus according to the application example, the display processor may further display a route having been followed by the user and a route not having been followed by the user in display aspects different from each other.

The user can therefore readily recognize whether or not each of the routes displayed on the electronic apparatus has been followed by the user on the basis of the display aspect of the route.

### Application Example 9

The electronic apparatus according to the application example may be a portable electronic apparatus and attachable to a predetermined site of the user.

The user can therefore move with the hands free. The electronic apparatus is therefore suitable for sport.

### Application Example 10

In the electronic apparatus according to the application example, the predetermined site may be an arm or a wrist.

The user can therefore use the electronic apparatus as if it were, for example, a wristwatch.

### Application Example 11

A display processing method according to this application example is a display processing method executed by a computer of an electronic apparatus, the method including displaying a plurality of routes intended uses of which are specified by a user in different display aspects in accordance with the intended uses of the plurality of routes.

In general, in planning a plurality of routes in mountain climbing and other activities, the user has determined the intended use of each of the routes in advance in many cases. In view of the fact described above, displaying the routes in different display aspects in accordance with the intended uses specified by the user allows the user to readily distinguish the plurality of routes displayed on the electronic apparatus from one another.

### Application Example 12

A program according to this application example causes a computer of an electronic apparatus to display a plurality of routes intended uses of which are specified by a user in different display aspects in accordance with the intended uses of the plurality of routes.

In general, in planning a plurality of routes in mountain climbing and other activities, the user has determined the intended use of each of the routes in advance in many cases. In view of the fact described above, displaying the routes in different display aspects in accordance with the intended uses specified by the user allows the user to readily distinguish the plurality of routes displayed on the electronic apparatus from one another.

### BRIEF DESCRIPTION OF THE DRAWINGS

The invention will be described with reference to the accompanying drawings, wherein like numbers reference like elements.

FIG. 1 describes an overview of an electronic apparatus according to a first embodiment.

FIG. 2 is a functional block diagram for describing an example of the configuration of the electronic apparatus.

FIG. 3 describes an example of how a user specifies a route (main route).

FIG. 4 describes an example of how the user specifies a route (sub route).

FIG. 5 describes an example of how the user specifies a route (escape route).

FIG. 6 describes an example of how the user specifies a display aspect on an intended use basis.

FIGS. 7A and 7B describe an example of route data and an example of display aspect data.

FIG. 8 is a flowchart for describing an example of processes carried out by an information terminal in preparation for mountain climbing.

FIG. 9 is a flowchart for describing an example of processes carried out by the electronic apparatus on the day of the mountain climbing.

FIG. 10 describes an example in which the main route, the sub route, and the escape route are displayed in display aspects different from one another (in different colors).

FIG. 11 describes an example in which a route being selected from the main route, the sub route, and the escape route is displayed in a display aspect (in cyclically blinking form) different from those of the routes not being selected.

FIG. 12 describes an example in which a route being selected (main route) is so displayed that a route portion downstream of a current point is displayed in a display aspect (with broken line) different from the display aspect of a route portion upstream of the current point.

FIG. 13 describes an example in which a route being selected (main route) is so displayed that a route portion downstream of a current point is displayed in a display aspect (with cyclically reversed, broken line) different from the display aspect of a route portion upstream of the current point.

FIG. 14 describes an example in which a route being selected (main route) is so displayed that a route portion downstream of a current point is displayed in a display aspect (with moving arrows) different from the display aspect of a route portion upstream of the current point.

### DESCRIPTION OF EXEMPLARY EMBODIMENTS

A preferable embodiment of the invention will be described below in detail with reference to the drawings. The embodiment described below is not intended to unduly limit the contents of the invention set forth in the appended claims. Further, all configurations described below are not necessarily essential configuration requirements of the invention.

### 1. Embodiment of Electronic Apparatus

### 1-1. Overview of Electronic Apparatus

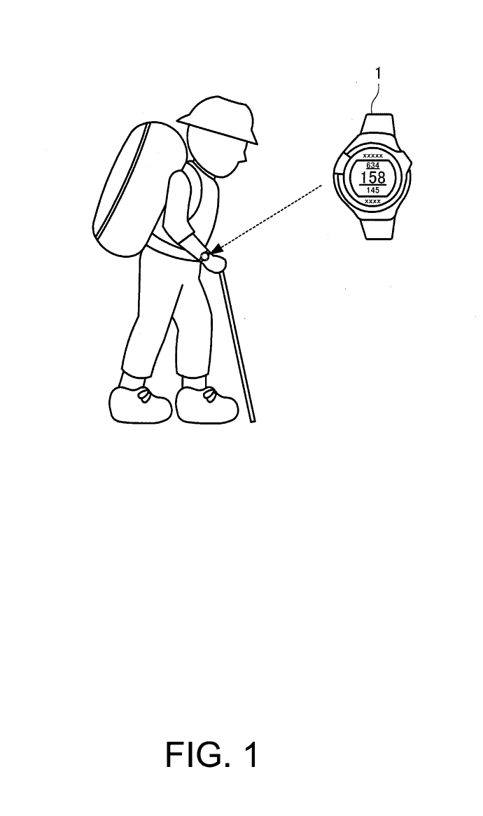

FIG. 1 describes an overview of an electronic apparatus according to a first embodiment.

An electronic apparatus 1 (example of portable electronic apparatus) according to the present embodiment is, for example, a mobile information apparatus attached to part of a user's body in an outdoor activity, such as mountain climbing, as shown in FIG. 1. A body part to which the electronic apparatus 1 is attached is a site in any position from the elbow to the hand (forearm) so that the electronic apparatus 1 is visible to the user whenever necessary. In the example shown in FIG. 1, the electronic apparatus 1 is configured as a wrist-worn-type (wristwatch-type) mobile information apparatus (outdoor watch), and the site to which the electronic apparatus 1 is attached is the wrist.

The electronic apparatus 1 has, for example, a clock function, a positioning function, a compass function, an altitude (or atmospheric pressure) detection function, and a navigation function, which are functions as an outdoor watch. The following description will be made on the assumption that the electronic apparatus 1 is used in mountain climbing.

On the day before mountain climbing, the user operates an information terminal, such as a smartphone, a tablet PC, and a desktop PC, to specify a planned climbing route in the information terminal and register the specified route in the electronic apparatus 1 via the information terminal.

On the day of the mountain climbing, the user who carries (wears) the electronic apparatus 1 can invoke the registered route and display it on the display screen of the electronic apparatus 1 and let the electronic apparatus 1 guide (navigate) the user along the route. The user does not need to operate the information terminal on the day of the mountain climbing as long as the user registers the route in advance.

In the present embodiment, the user can register a main route, which is a primary route, as well as a sub route, an escape route, and other routes in the electronic apparatus 1.

The main route is a primary route along which the user should travel and is, for example, a route from a point from which the user ascends the mountain to a mountain villa.

The sub route is a reserve route along which the user plans to travel in a case where the user has spare time or physical strength on the day of the mountain climbing and is a route that temporarily strays off the main route. The sub route is a route that starts from a point on the main route (first point, for example, halfway point on main route) and ends at a point on the main route (second point, for example, halfway point on main route). The start point and the endpoint are arbitrary points on the main route and may be the same point of different points.

The escape route is a route that allows the climber to quickly descend the mountain, for example, in a case where an unexpected situation occurs on the day of the mountain climbing and the climber or a climbing companion cannot continue the mountain climbing. The escape route is a route that starts from a point on the main route (for example, halfway point on main route) and ends at a point that is not on the main route.

### 1-2. Specifying Main Route

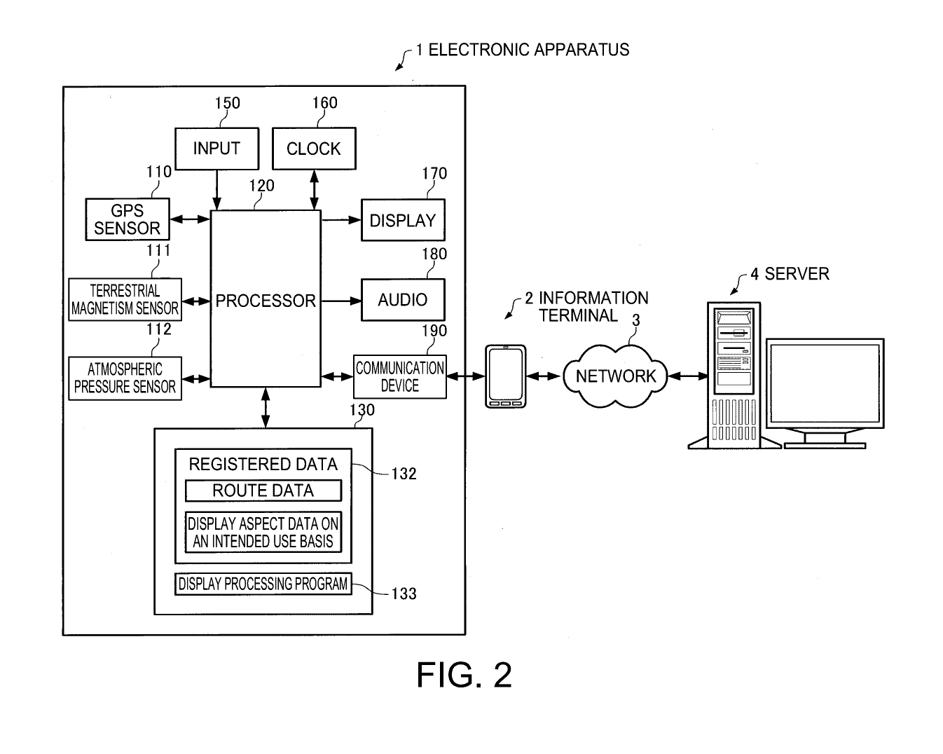

In preparation for mountain climbing, the electronic apparatus 1 is connected to an information terminal 2 (example of electronic apparatus), and the information terminal 2 is connected to a network 3, such as the Internet, as shown, for example, in FIG. 2. The following description will be made on the assumption that a touch panel is used as a user interface of the information terminal 2.

The user first operates the information terminal 2 to access a network server 4, causes the network server 4, which stores a world atlas, to display a map of a desired area on the display screen (such as touch-panel-type display) of the information terminal 2, and views the map. The user then enlarges, reduces, scrolls, and otherwise processes the map on the information terminal 2 and causes the information terminal 2 to display an area including the main route.

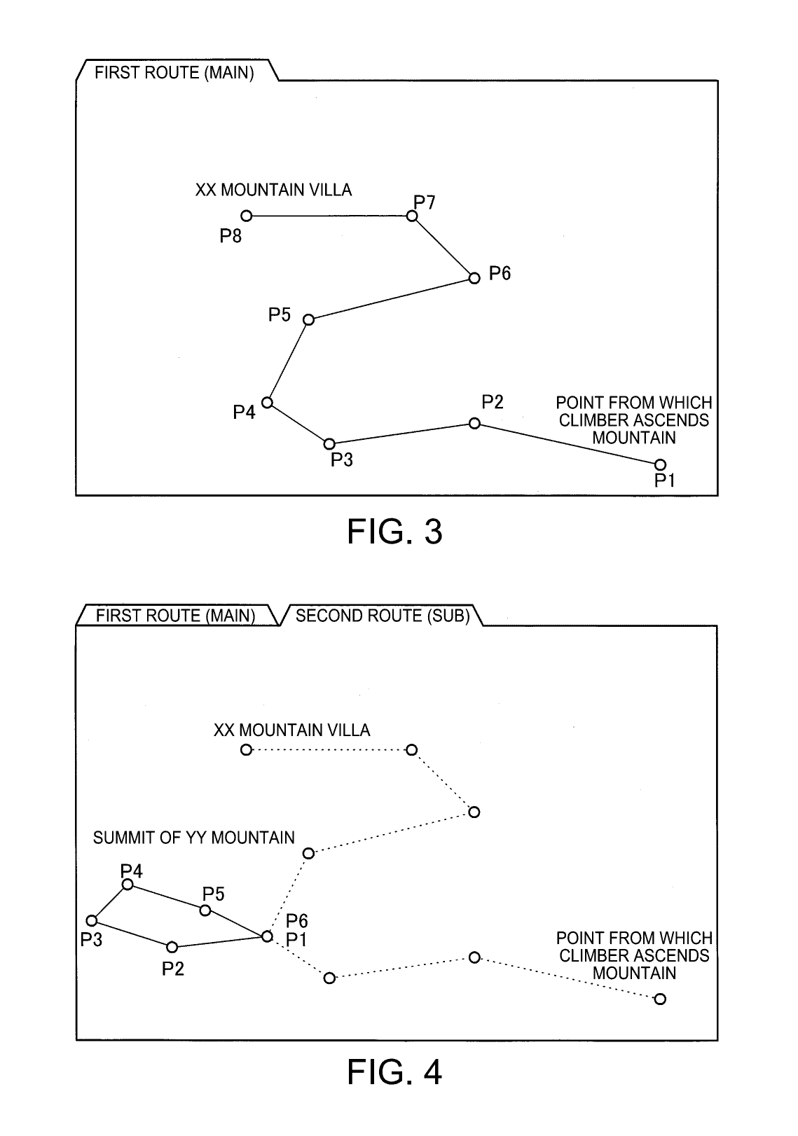

The user then specifies (touches) points P1, P2, P3, . . . on the main route sequentially from the start point P1 of the route, as shown in FIG. 3. When the user completes the specification of a goal point that is the last point (point P8 in FIG. 3), the user inputs a completion notification to the information terminal 2.

Each of the “points” used herein is a position on the route. Therefore, the “points” may include points where a user plans to do some events (such as rest and lunch) (event points), may include a point where another route branches off, or may include any other point.

The information terminal 2 connects the plurality of points P1, P2, P3, . . . specified by the user to each other in the order in which they have been specified to create a route, takes the created route as a route specified by the user, and downloads a local map (including topographic data) that includes the route from the network server 4.

The information terminal 2 may take a zigzag route created by connecting the plurality of points P1, P2, P3, . . . to each other in the order in which they have been specified as the route specified by the user, may take a smooth curved route created by interpolating or smoothing the zigzag route as the route specified by the user, or may take the center line of a route on the map that is closest to the zigzag route as the route specified by the user.

The user can therefore specify a route with no crossing or traffic sign, as in the case of a climbing route, in the information terminal 2.

The information terminal 2 extracts the coordinates (latitude, longitude, and altitude) of the positions of the plurality of points P1, P2, P3, . . . located on the route specified by the user from the topographic data contained in the local map and creates data representing the configuration of the route in the form of data created by arranging the coordinates of the positions of the plurality of points P1, P2, P3, . . . in the order of the point number. The configuration of the route shown in FIG. 3 is therefore represented, for example, by a set of coordinates of the positions of the eight points P1 to P8.

The coordinates (latitude, longitude, and altitude) of the position of a point Pn are the coordinates representing the absolute position of the point Pn on the earth.

When the user desires to register a detailed shape of the route in the electronic apparatus 1, the user only needs to increase the number of points specified on the map.

When specifying a route, the user can also input attributes of a plurality of points that form the route to the information terminal 2. Examples of a point with an attribute may include “a rest point,” “a lunch point,” “a branch point,” and “a photographing point,” and the attribute is, for example, an event name or a comment inputted by the user. The attribute of a point may be inputted, for example, in the form of a text or by selection of any of a plurality of icons (marks) prepared in advance.

When specifying the route, the user can also input the date and time when the user desires to depart from the start point of the route, the date and time when the user desires to arrive at the goal point of the route, and other types of information to the information terminal 2. The date and time are inputted, for example, in the form of a text (numerals).

### 1-3. Specifying Sub Route

How to specify the sub route is basically the same as how to specify the main route. The user specifies (touches) points P1, P2, P3, . . . on the sub route sequentially from the start point P1 of the route, as shown in FIG. 4. When the user completes the specification of a goal point that is the last point (point P6 in FIG. 4), the user inputs a completion notification to the information terminal 2.

In the example shown in FIG. 4, the start point P1 and the goal point P6 of the sub route coincide with the halfway point P4 on the main route (see FIG. 3).

### 1-4. Specifying Escape Route

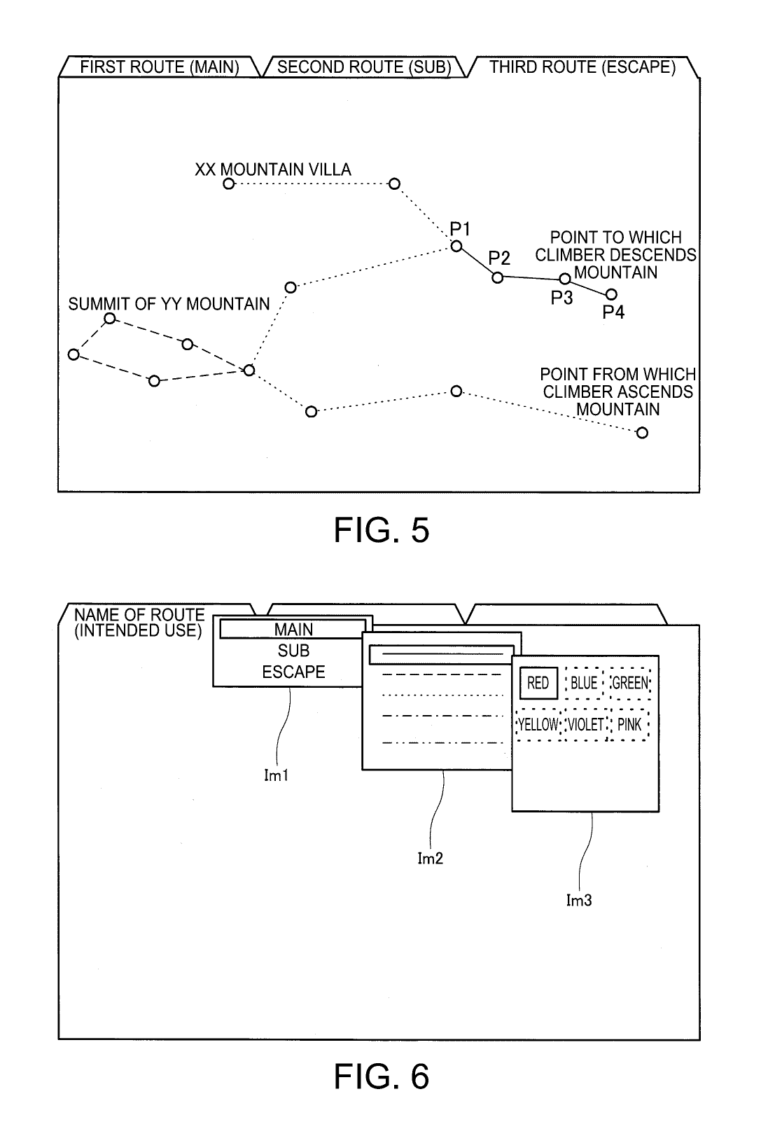

How to specify the escape route is also basically the same as how to specify the main route. The user specifies (touches) points P1, P2, P3, . . . on the escape route sequentially from the start point P1 of the route, as shown in FIG. 5. When the user completes the specification of a goal point that is the last point (point P4 in FIG. 5), the user inputs a completion notification to the information terminal 2.

In the example shown in FIG. 5, the start point P1 of the escape route coincides with the halfway point P6 on the main route (see FIG. 3).

### 1-5. Specifying Intended Use and Others

The following description will also be made on the assumption that a touch panel is used as the user interface of the information terminal 2.

When specifying a route, the user can input, on the route specification screen (FIGS. 3 to 5), the name of a route to be specified (such as first route and second route), an intended use of the route (such as main and sub), and the display aspect of the intended use (such as line type) to the information terminal 2.

For example, as shown in FIG. 6, the user touches a location to which a name is inputted (text image expressed as “Route name” in FIG. 6) on the route specification screen to cause the information terminal 2 to display a text input screen that is not shown and inputs a name of the route (“first route,” for example) in the form of a text. When the user inputs an input completion notification to the information terminal 2, the information terminal 2 recognizes the name inputted by the user (such as “first route”).

The user touches a location to which an intended use is inputted (text image expressed as “intended use” in FIG. 6) on the route specification screen to cause the information terminal 2 to display an intended use selection screen (pulldown menu) Im1, as shown in FIG. 6. On the selection screen Im1 are listed candidates of the intended use, such as “main,” “sub,” and “escape.”

When the user touches a desired intended use (“main,” for example) on the selection screen Im1, the information terminal 2 recognizes the intended use (main) specified by the user.

The user further touches for a long period the intended use being specified (“main,” for example) on the route specification screen to cause the information terminal 2 to display a selection screen (pulldown menu) Im2, on which the user selects the line type (one kind of display aspect), as shown in FIG. 6. On the selection screen Im2 are listed candidates of the line type (images of thick solid line, thin solid line, broken line, dashed line, and other lines).

When the user touches a desired line type (solid line image, for example) on the selection screen Im2, the information terminal 2 recognizes the line type (solid line) specified by the user in association with the intended use.

The user further touches for a long period the line type being specified (solid line) on the route specification screen to cause the information terminal 2 to display a selection screen (pulldown menu) Im3, on which the user selects the line color (one kind of display aspect), as shown in FIG. 6. On the selection screen Im3 are listed candidates of the line color (red, blue, green, and other samples). (It is, however, noted that since colors cannot be expressed in the drawings, different colors are expressed in the form of different texts in FIG. 6.)

When the user touches a desired line color (red sample, for example) on the selection screen Im3, the information terminal 2 recognizes the line color (red) specified by the user.

The user then specifies the name, the intended use, and the display aspect described above in association with each of the main route, the sub route, and the escape route. It is, however, noted that the user may omit specification of the name associated with at least one route. In this case, a name assigned as a default is taken as a name specified by the user. Further, the user may omit specification of the display aspect associated with at least one intended use. In this case, a display aspect assigned as a default is taken as a display aspect specified by the user.

Further, when the user specifies the display aspect in association with at least one intended use, the information terminal 2 desirably removes the display aspect having been already assigned by the user to any other intended use from display aspect candidates presented to the user (limits the number of display aspect candidates).

The user can therefore assign desired display aspects (combination of line type and line color) different from one another to a plurality of intended uses different from one another.

The information terminal 2 then creates the configuration of each of the plurality of routes specified by the user, the name of each of the plurality of routes, the intended use of each of the plurality of routes, the display aspect on an intended use basis (combination of line type and line color), and other types of data.

In the following description, data on the configuration of a route, the name of the route, the intended use of the route, and other types of data on the route are referred to as “route data,” and data representing the display aspect on an intended use basis is referred to as “display aspect data.” The route data and the display aspect data are stored as registered data 132 in a memory 130 of the electronic apparatus 1.

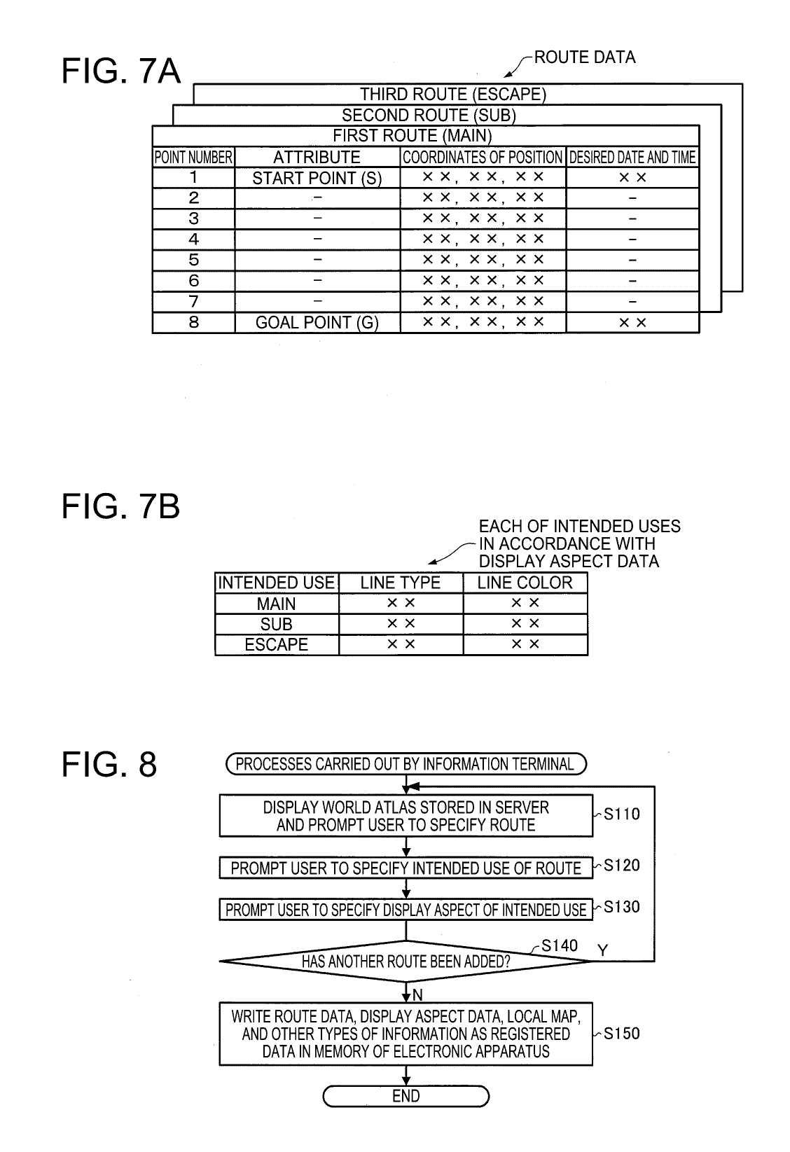

FIG. 7A shows a visualized example of the data structure of the route data (example of information representing the intended use of each of a plurality of routes). FIG. 7B shows a visualized example of the data structure of the display aspect data (example of information representing the relationship between a plurality of intended uses and a plurality of display aspects).

### 1-6. Configuration of Electronic Apparatus and Others

FIG. 2 is a functional block diagram for describing the configuration of the electronic apparatus and others.

The electronic apparatus 1 includes a GPS sensor 110, a terrestrial magnetism sensor 111, an atmospheric pressure sensor 112, a processor (example of display processor) 120, a memory 130, an input 150, a clock 160, a display 170, an audio 180, a communication device 190, and other components, as shown in FIG. 2. In the configuration of the electronic apparatus 1, however, part of the constituent elements described above may be omitted or changed, or another constituent element may be added.

The GPS sensor 110 is a sensor that produces positioning data (latitude, longitude, and altitude) representing the position of the electronic apparatus 1 and outputs the positioning data to the processor 120, and the GPS sensor 110 includes, for example, a GPS (global positioning system) receiver and other components. The GPS sensor 110 receives an externally incoming electromagnetic wave that belongs to a predetermined frequency band via a GPS antenna that is not shown, extracts a GPS signal from a GPS satellite, and produces the positioning data representing the position of the electronic apparatus 1 on the basis of the GPS signal.

The terrestrial magnetism sensor 111 is a sensor that detects a terrestrial magnetism vector representing the terrestrial magnetic field direction viewed from the electronic apparatus 1 and produces, for example, terrestrial magnetism data representing magnetic flux densities in three axial directions perpendicular to each other. The terrestrial magnetism sensor 111 is, for example, an MR (magnet resistive) element, an MI (magnet impedance) element, or a Hall element.

The atmospheric pressure sensor 112 is a sensor that detects the atmospheric pressure around the electronic apparatus 1 and has, for example, a pressure sensitive element operating on the basis of a method using a change in the resonance frequency of a vibrating piece (vibration method). The pressure sensitive element is a piezoelectric vibrator made, for example, of quartz, lithium niobate, lithium tantalate, or any other piezoelectric material and is, for example, a tuning-fork-type vibrator, a dual-tuning-fork-type vibrator, an AT vibrator (thickness shear vibrator), or an SAW resonator. The output from the atmospheric pressure sensor 112 may be used to correct the altitude information contained in the positioning data from the GPS sensor 110 or compensate the altitude information.

The processor 120 is formed, for example, of a CPU (central processing unit), a DSP (digital signal processor), and an ASIC (application specific integrated circuit). The processor 120 carries out a variety of processes in accordance with a variety of programs stored in the memory 130, such as a display processing program 133 (example of program), and a variety of commands inputted by the user via the input 150. The processes carried out by the processor 120 include data processing in which data produced by the GPS sensor 110, the terrestrial magnetism sensor 111, and the atmospheric pressure sensor 112 are processed, display processing in which the display 170 is caused to display an image, audio processing in which the audio 180 is caused to output audio, and other types of processing.

The memory 130 is formed, for example, of one or more IC memories and has a ROM that memorizes the display processing program 133 and other types of data and a RAM that serves as a work area used by the processor 120. The RAM includes a nonvolatile RAM, and the nonvolatile RAM provides a memory area, where the registered data 132 is memorized, and other areas.

The input 150 is formed, for example, of buttons, keys, a microphone, a touch panel, a voice recognition function, and an action detection function based on an accelerometer, converts an instruction from the user into an appropriate signal, and transmits the signal to the processor 120.

The clock 160 is formed, for example, of a real-time clock (RTC) IC, produces time data, such as the year, month, date, hour, minute, and second, and transmits the time data to the processor 120.

The display 170 is formed, for example, of an LCD (liquid crystal display), an organic EL (electroluminescence) display, an EPD (electrophoretic display), or a tough-panel-type display and displays a variety of images in accordance with an instruction from the processor 120.

The audio 180 is formed, for example, of a loudspeaker, a buzzer, a vibrator and produces a variety of type of audio (or vibration) in accordance with an instruction from the processor 120.

The communication device 190 performs a variety of types of control for establishing data communication between the electronic apparatus 1 and the information terminal 2 (such as smartphone). The communication device 190 includes a transceiver that complies, for example, with Bluetooth (registered trademark) (including BTLE: Bluetooth Low Energy), Wi-Fi (registered trademark) (Wi-Fi: wireless fidelity), Zigbee (registered trademark), NFC (near field communication), Ant+, and other short-distance wireless communication standards.

The information terminal 2 is a smartphone, a tablet PC, a desktop PC, or any other information terminal connectable to the network 3, such as the Internet, and incorporates a communication device that is not shown but corresponds to the communication device 190 of the electronic apparatus 1. A program associated with the electronic apparatus 1 is installed in a memory of the information terminal 2, and the information terminal 2 operates in accordance with the program. The program is, for example, downloaded from the network server 4 over the network 3, such as the Internet.

The network server 4 is a network server connected to the network 3, such as the Internet. The network server 4 has a function of managing data and other types of information uploaded from the user of the electronic apparatus 1 on a user basis. The network server 4 further has a function of providing the user of the electronic apparatus 1 with a program and map data.

### 1-7. Processes Carried Out by Information Terminal

FIG. 8 is a flowchart for describing processes carried out by the information terminal 2 in preparation for mounting climbing. In the preparation, it is assumed that the information terminal 2 is connected to the network 3 and the electronic apparatus 1. The steps in FIG. 8 will be sequentially described below.

Step S110: The information terminal 2 displays the world atlas stored in the network server 4 and prompts the user to specify a route on the map. How the user specifies a route has been described above (see FIG. 3 and other figures).

Step S120: The information terminal 2 prompts the user to specify an intended use of the route. How the user specifies an intended use has been described above (see FIG. 6 and other figures).

Step S130: The information terminal 2 prompts the user to specify the display aspect of the intended use. How the user specifies a display aspect has been described above (see FIG. 6 and other figures).

Step S140: The information terminal 2 evaluates whether or not the user has inputted an instruction to add a route. When a result of the evaluation shows that the input has been made (Y in step S140), the control proceeds to step S110, whereas when a result of the evaluation shows that the input has not been made (N in step S140), the control proceeds to step S150. The user can therefore sequentially specify a plurality of routes. For example, the user sequentially specifies a main route (see FIG. 3), a sub route (see FIG. 4), and an escape route (see FIG. 5).

Step S150: The information terminal 2 prepares route data (see FIG. 7A), display aspect data (see FIG. 7B), a local map including the specified plurality of routes (main route, sub route, and escape route), and other types of information, writes these data as the registered data 132 in the memory 130 of the electronic apparatus 1, and terminates the procedure. The routes have thus been registered.

### 1-8. Processes Carried Out by Electronic Apparatus

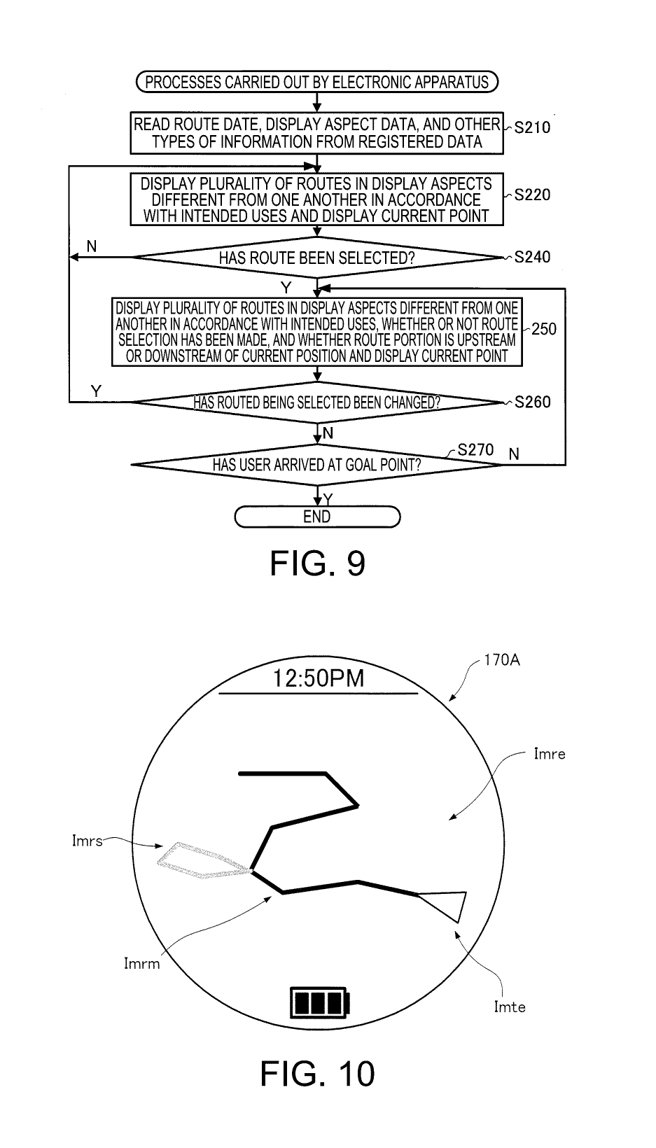

FIG. 9 is a flowchart for describing processes carried out by the processor 120 of the electronic apparatus 1 (processes associated with navigation) on the day of the mountain climbing. It is assumed that the user carries the electronic apparatus 1 alone on the day of the mountain climbing and inputs an instruction to start the processes in the flowchart to the electronic apparatus 1 when the user starts the mountain climbing. The steps in FIG. 9 will be sequentially described below.

Step S210: The processor 120 of the electronic apparatus 1 reads the route data on the plurality of routes (FIG. 7A), the display aspect data (FIG. 7B), and other types of information from the registered data 132 in the memory 130.

Steps 220: The processor 120 displays images of the plurality of routes on the display 170 in display aspects different from one another in accordance with the intended uses of the routes on the basis of the route data on the plurality of routes, the display aspect data, and the other types of information and also displays the current point on the display 170, for example, as shown in FIG. 10. In addition, an image of the remaining amount of a battery, a text image of the current time, and other types of information are further displayed on the display 170.

Before displaying the information described above, the processor 120 creates images of the plurality of routes in accordance with the route data (FIG. 7A). The processor 120 sets the display aspect associated with each of the intended uses in accordance with the display aspect data (FIG. 7B). The processor 120 calculates the coordinates of the position of the current point on the basis of an output form the GPS sensor 110 (positioning data), an output from the atmospheric pressure sensor 112 (atmospheric pressure data), and other types of information.

In FIG. 10, reference character 170A denotes a display screen (having a circular shape in the description) of the display 170. Reference character Imrm denotes an image of the route the intended use of which has been specified to be “main” by the user (main route). Reference character Imrs denotes an image of the route the intended use of which has been specified to be “sub” by the user (sub route). Reference character Imre denotes an image of the route the intended use of which has been specified to be “escape” by the user (escape route). Reference character Imte denotes a mark representing the current point. (In FIG. 10, the image of each of the routes is shown in the form of a zigzag line and may instead be shown in the form of a smooth curved line).

The display aspect of the image Imrm of the main route is set to be the display aspect (combination of solid line and black in FIG. 10) specified in advance by the user in accordance with the intended use of the route (that is, “main”).

The display aspect of the image Imrs of the sub route is set to be the display aspect (combination of solid line and dark gray in FIG. 10) specified in advance by the user in accordance with the intended use of the route (that is, “sub”).

The display aspect of the image Imre of the escape route is set to be the display aspect (combination of solid line and light gray in FIG. 10) specified in advance by the user in accordance with the intended use of the route (that is, “escape”).

A mark Imte representing the current point is, for example, an arrow mark, and the orientation of the arrow coincides with the orientation of the electronic apparatus 1 on the route (for example, 12-o'clock direction in a case where the display screen is considered as a 12-hour-clock dial). The orientation of the electronic apparatus 1 is calculated on the basis of the output from the terrestrial magnetism sensor 111 (terrestrial magnetism data).

At the beginning after the user starts the mountain climbing, the current point mark Imte is located at the start point of the main route, as shown in FIG. 10. When the 12-o'clock direction of the electronic apparatus 1 coincides with the direction in which the route extends, the arrow of the mark Imte also aligned with the direction in which the route extends.

At this point, the user selects a route along which the user intends to travel (main route at the beginning after the user starts the mountain climbing) from the plurality of routes displayed on the display screen 170A and inputs a result of the selection to the electronic apparatus 1 via the input 150. For example, the user pushes a button provided on the input 150 to cyclically change the candidates of the route to be selected and pushes another button provided on the input 150 during the period for which a desired route can be selected to input the result of the selection (selected route) to the electronic apparatus 1.

The above description has been made with reference to the case where a button on the input 150 is used for the user's input to the electronic apparatus 1. Instead, any of the other user interfaces incorporated in the electronic apparatus 1 (such as touch panel, voice recognition function, and action detection function based on accelerometer) may be used (the same holds true for the following description).

Step 240: The processor 120 evaluates whether or not a result of the route selection made by the user has been inputted. When a result of the evaluation shows that the result has been inputted (Y in step S240), the control proceeds to step S250, whereas when a result of the evaluation shows that the result has not been inputted (N in step S240), the control proceeds to step S220.

Step S250: The processor 120 displays the same contents as in step S220. The processor 120 in this step, however, so sets the display aspect of the route being selected as to differ from the display aspects or the routes not being selected.

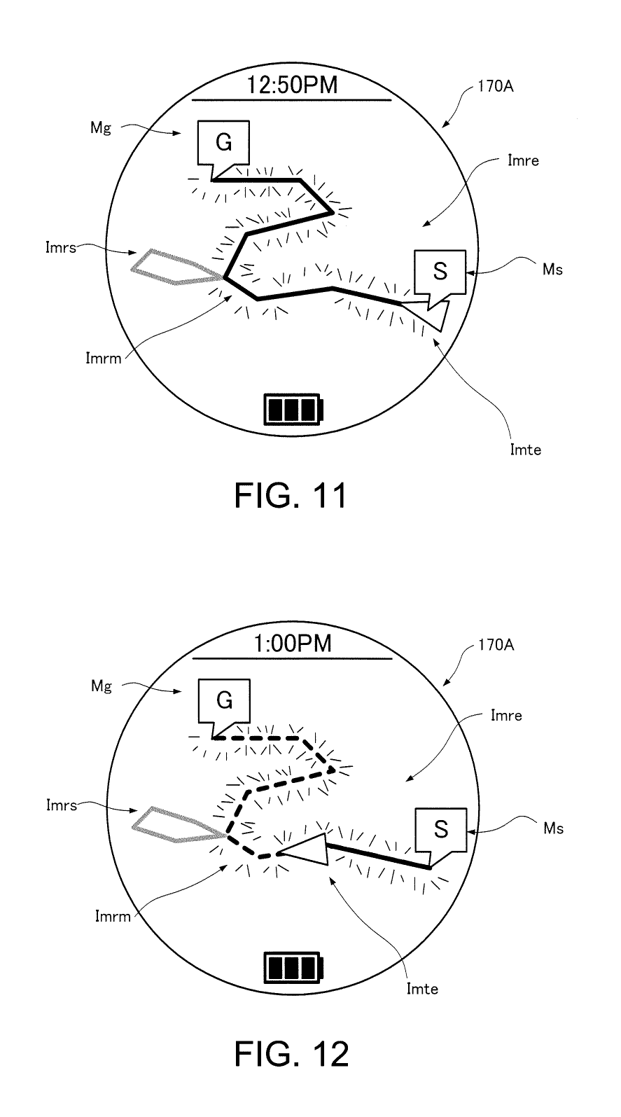

For example, as shown in FIG. 11, the processor 120 displays the route being selected (main route in FIG. 11) from the plurality of routes in a highlighted form (blinking form, for example). FIG. 11 shows that the route being selected is displayed in a blinking form in which a large number of radial marks are displayed around the route.

The processor 120 further displays an attribute mark of the route being selected (main route in FIG. 11) in a relevant position on the route, as shown in FIG. 11. The attribute mark of a route is a mark representing an attribute inputted in advance by the user in association with each of several points that form the route. Examples of the attribute mark include a mark Ms representing the start point (S) of the route and a mark Mg representing the goal point (G) of the route.

The processor 120 in step 250, when carried out at a second time or later, so sets the display aspect of a route portion upstream (example of route having been followed by user) of the current point (reference character Imte) as to differ from the display aspect of a route portion downstream (example of route not having been followed by user) of the current point (reference character Imte), as shown in FIG. 12. In FIG. 12, the route portion upstream of the current point (Imte) has a display aspect of a solid line, and the route portion downstream of the current point (Imte) has a display aspect of a broken line.

During the travel along the main route, when the user judges that the user has sufficient spare time and physical strength and decides to travel along the sub route, the user operates at this point a predetermined button on the input 150 to input an instruction to change the route being selected to the sub route to the electronic apparatus 1. Instead, during the travel along the main route or the sub route, when the user judges that the user does not have spare time or physical strength and decides that the user should descend the mountain via the escape route, the user also operates at this point a predetermined button on the input 150 to input an instruction to change the route being selected to the escape route to the electronic apparatus 1.

Step S260: The processor 120 evaluates whether or not a notification of the route change has been inputted from the user via the input 150. When a result of the evaluation shows that the notification has been inputted (Y in step S260), the control proceeds to step S220, whereas when a result of the evaluation shows that the notification has not been inputted (N in step S260), the control proceeds to step S270.

Step S270: The processor 120 evaluates whether or not the current point (reference character Imte in FIG. 12) coincides with the goal point (reference character Mg in FIG. 12) of the route being selected. When a result of the evaluation shows that the two points coincide with each other (Y in step S270), the procedure is terminated, whereas when a result of the evaluation shows that the two points do not coincide with each other (N in step S270), the control proceeds to step S250.

### 2. Supplementary Description of Embodiment

In the embodiment described above, the routes registered in the electronic apparatus 1 are only the following three.

(1) Route the intended use of which is “main” (main route)

(2) Route the intended use of which is “sub” (sub route)

(3) Route the intended use of which is “escape” (escape route)

Instead, the number of main routes registered in the electronic apparatus 1 may be two or more, the number of sub routes may be two or more, and the number of escape routes may be two or more. For example, the following routes (1) to (20) may be registered in the electronic apparatus 1.

(1) Main route for ascending on the first day

(2) First sub route for ascending on the first day

(3) Second sub route for ascending on the first day

(4) First escape route for ascending on the first day

(5) Second escape route for ascending on the first day

(6) Main route for descending on the first day

(7) First sub route for descending on the first day

(8) Second sub route for descending on the first day

(9) First escape route for descending on the first day

(10) Second escape route for descending on the first day

(11) Main route for ascending on the second day

(12) First sub route for ascending on the second day

(13) Second sub route for ascending on the second day

(14) First escape route for ascending on the second day

(15) Second escape route for ascending on the second day

(16) Main route for descending on the second day

(17) First sub route for descending on the second day

(18) Second sub route for descending on the second day

(19) First escape route for descending on the second day

(20) Second escape route for descending on the second day

It is, however, noted that even when a plurality of routes have been registered in the electronic apparatus 1, a plurality of routes used in different points of time are not necessarily displayed at the same time on the display 170. For example, among the routes (1) to (20) described above, the routes on different dates are not necessarily displayed at the same time, and a route for ascending and a route for descending on the same date but in different time frames are possibly not necessarily displayed at the same time because the two routes are used at different points of time.

In consideration of the above, the processor 120 of the electronic apparatus 1 may limit the number of combinations of a plurality of routes simultaneously displayed on the display 170 in accordance with date/time data (such as desired date and time) associated with a plurality of registered routes, the user's request, and other factors.

Further, in the embodiment described above, the “sub” is prepared as one kind of intended use of a route, and detailed intended uses corresponding to levels lower than “sub” may be prepared. Example of the intended uses lower than “sub” may include “a sub route that leads to summit,” “a sub route that leads to rest place,” and “a sub route that leads place for beautiful scenery.” Similarly, detailed intended uses corresponding to levels lower than “main” may be prepared, and detailed intended uses corresponding to levels lower than “escape” may be prepared.

In the embodiment described above, both the sub route and the escape route are registered in the apparatus, and only one of them may instead be registered.

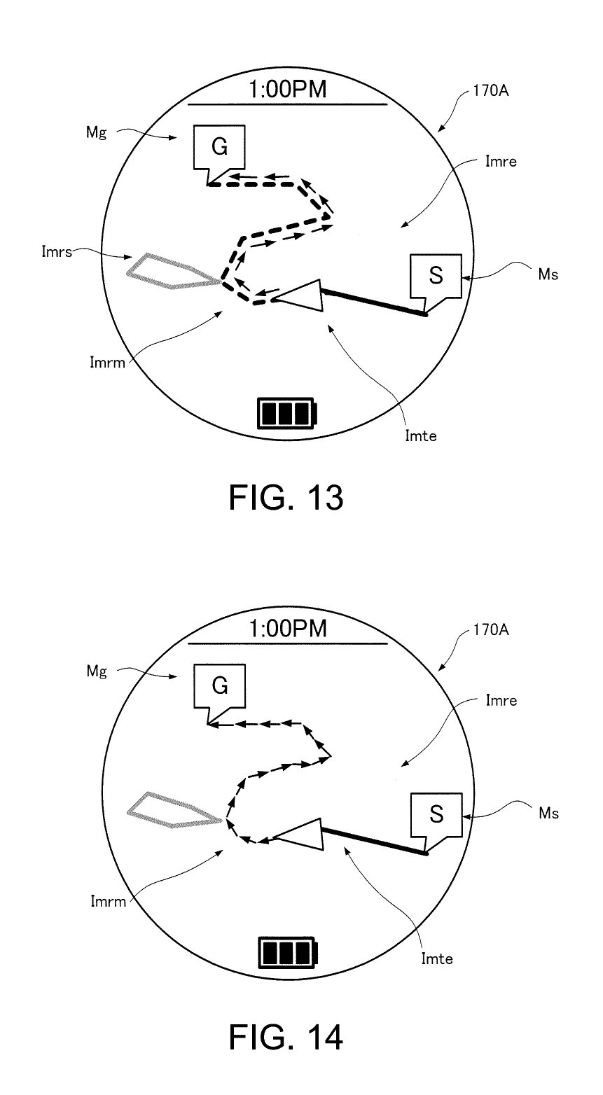

In the embodiment described above, the line color, line type, blinking or not blinking, and other attributes are used as the display aspect, and other display aspects may instead be used. For example, a route drawn with the broken line may be regularly reversed from bright to dark and vice versa, or the bright/dark phase may be shifted toward a goal point (animation display). When the bright/dark phase is shifted, the route is displayed as if a bright/dark pattern were moving along the route, as shown in FIG. 13. Instead, a route may be drawn with a plurality of successive short arrows, and the short arrows may be gradually shifted toward a goal point (animation display).

In the embodiment described above, the display aspect specified by the user on an intended use basis is a combination of the line color and the line type. Instead, the display aspect may be a combination of at least two of the line color (line density), the line type, blinking or not blinking, and the animation type (“animation” used herein includes blinking and other types of action) or may be formed of only one of them.

In the embodiment described above, the intended use of a route is expressed only on the basis of the display aspect, and a text image or a mark may be used in conjunction with the display aspect. For example, in a vicinity of the image of the main route, a text image indicating that the intended use of the route is “main” or a mark indicating that the intended use of the route is “main” may be displayed. Similarly, in a vicinity of the image of the sub route, a text image indicating that the intended use of the route is “sub” or a mark indicating that the intended use of the route is “sub” may be displayed. Still similarly, in a vicinity of the image of the escape route, a text image indicating that the intended use of the route is “escape” or a mark indicating that the intended use of the route is “escape” may be displayed.

In the embodiment described above, the route display direction on the display screen (and current point mark display direction) may be rotated in accordance with the actual direction of the electronic apparatus 1. The north side of the map may be fixed to the 12-o'clock direction of the electronic apparatus 1, and the rotation or the fixation described above may be set in advance by the user.

In the embodiment described above, part of the function of the network server 4 (function of storage of user data, for example) may be incorporated in the information terminal 2 or the electronic apparatus 1, or part of the function of the information terminal 2 or the electronic apparatus 1 may be incorporated in the network server 4. Further, in the embodiment described above, part or entirety of the function of the electronic apparatus 1 may be incorporated in the information terminal 2, or part or entirety of the function of the information terminal 2 may be incorporated in the electronic apparatus 1.

### 3. Advantageous Effects of Embodiment

As described above, the electronic apparatus 1 according to the present embodiment includes a display processor (processor 120 in step S250) that displays a plurality of routes the intended uses of which are specified by the user in different display aspects in accordance with the intended uses of the plurality of routes.

In general, in planning a plurality of routes in mountain climbing and other activities, the user has determined the intended use of each of the routes in advance in many cases. In view of the fact described above, configuring the display processor (processor 120 in step S250) to display the routes in the different display aspects in accordance with the intended uses specified by the user allows the user to readily distinguish the plurality of routes displayed on the electronic apparatus 1 from one another.

The electronic apparatus 1 according to the present embodiment further includes the memory 130, which memorizes, as information that the display processor (processor 120 in step S250) refers to (registered data 132), information representing the intended uses of the plurality of routes (route data) and information representing the relationship between the plurality of intended uses and the plurality of display aspects (display aspect data).

The display processor (processor 120 in step S250) can therefore handle the display aspects associated with the intended uses as pre-memorized information. The user can therefore recognize the intended use of each of the routes displayed on the electronic apparatus 1 on the basis of the display aspect of the route.

In the electronic apparatus 1 according to the present embodiment, the plurality of routes include at least one of a sub route that is a reserve route and an escape route that allows the user to escape from a main route that is a primary route, and the main route.

The user can therefore readily identify each of the routes displayed on the electronic apparatus 1 as the main route or the sub route or can readily identify each of the displayed routes as the main route or the escape route.

In the electronic apparatus 1 according to the present embodiment, the sub route is a route having a first point on the main route as the start point and a second point on the main route as the goal point.

The main route and the sub route, which share part of the points on the two routes, are considered to be difficult for the user to distinguish. However, since the display processor (processor 120 in step S250) displays the main route and the sub route in display aspects different from each other, the user can readily identify each of the intended uses of the routes displayed on the electronic apparatus 1 as main or sub on the basis of the display aspect of the route.

In the electronic apparatus 1 according to the present embodiment, the escape route is a route having one of the points on the main route as a start point and the point that is not on the main route as the goal point.

The main route and the escape route, which share part of the points on the two routes, are considered to be difficult for the user to distinguish. However, since the display processor (processor 120 in step S250) displays the main route and the escape route in display aspects different from each other, the user can readily identify the intended use of each of the routes displayed on the electronic apparatus 1 as main or escape on the basis of the display aspect of the route.

In the electronic apparatus 1 according to the present embodiment, the display processor (processor 120) displays a plurality of routes in different line colors or line types in accordance with the intended uses of the plurality of routes.

The display processor (processor 120 in step S250) can therefore display the routes in different line colors or line types in accordance with the intended uses specified by the user. The user can therefore readily recognize the intended use of each of the routes displayed on the electronic apparatus 1 on the basis of the line color or line type of the route.

In the electronic apparatus 1 according to the present embodiment, the display processor (processor 120) further displays a route being selected by the user and routes not being selected by the user in display aspects different from one another.

The user can therefore readily recognize whether or not each of the routes displayed on the electronic apparatus 1 is being selected on the basis of the display aspect of the route.

In the electronic apparatus 1 according to the present embodiment, the display processor (processor 120) further displays a route having been followed by the user and a route not having been followed by the user in display aspects different from each other.

The user can therefore readily recognize whether or not each of the routes displayed on the electronic apparatus 1 has been followed by the user on the basis of the display aspect of the route.

The electronic apparatus 1 according to the present embodiment is a portable electronic apparatus and attachable to a predetermined body site of the user.

The user can therefore move with the hands free. The electronic apparatus 1 is therefore suitable for a variety of types of sport, such as walking, running, trail running, mountain climbing, bicycling, back-country skiing, and snowshoeing.

In the electronic apparatus 1 according to the present embodiment, the predetermined site is an armor a wrist.

The user can therefore use the electronic apparatus 1 as if it were, for example, a wristwatch.

### 4. Other Variations

The invention is not limited to the embodiment described above, and a variety of variations are conceivable within the scope of the substance of the invention.

For example, the electronic apparatus 1 or the information terminal 2 may incorporate known functions of a smartphone, such as a camera function, a call function, and an action sensing function (for example, acceleration sensor, angular velocity sensor, and other types of inertia sensors).

The electronic apparatus 1 or the information terminal 2 may further incorporate a biological activity sensing function, for example, a temperature sensor, a humidity sensor, and a pulse sensor.

The electronic apparatus 1 or the information terminal 2 can be configured as a wrist-worn electronic apparatus, a smartphone, a head mounted display (HMD), and a variety of other types of mobile information apparatus.

The electronic apparatus 1 or the information terminal 2 in the embodiment described above notifies the user of information primarily in the form of image display and may instead perform the notification in the form of audio, vibration, or any other type of action or a combination of at least two of the image display, audio, and vibration.

In the embodiment described above, a GPS (global positioning system) is used, and a global navigation satellite system (GNSS) or any other system may instead be used. For example, one of or two or more of EGNOS (European Geostationary-Satellite Navigation Overlay Service), QZSS (Quasi Zenith Satellite System), GLONASS (GLObal NAvigation Satellite System), GALILEO, BeiDou (BeiDou Navigation Satellite System), and other satellite positioning systems may be used. Further, WAAS (Wide Area Augmentation System), EGNOS (European Geostationary-Satellite Navigation Overlay Service), or any other satellite-based augmentation system (SBAS) may be used as at least one of the satellite positioning systems.

The embodiment and the variations described above are presented by way of example, and the invention is not limited thereto. For example, the embodiment and any of the variations can be combined with each other as appropriate.

The invention encompasses substantially the same configuration as the configuration described in the embodiment (for example, a configuration having the same function, using the same method, and providing the same result or a configuration having the same purpose and providing the same effect). Further, the invention encompasses a configuration in which an inessential portion of the configuration described in the embodiment is replaced. Moreover, the invention encompasses a configuration that provides the same advantageous effects as those provided by the configuration described in the embodiment or a configuration that can achieve the same purpose as that achieved by the configuration described in the embodiment. Further, the invention encompasses a configuration in which a known technology is added to the configuration described in the embodiment.

What is claimed is:

1. An electronic apparatus comprising
a display processor that displays a plurality of routes intended uses of which are specified by a user in different display aspects on a display in accordance with the intended uses of the plurality of routes.

2. The electronic apparatus according to claim 1, further comprising
a memory that memorizes, as information that the display processor refers to,
information representing the intended uses of the plurality of routes, and
information representing a relationship between the plurality of intended uses and the plurality of display aspects.

3. The electronic apparatus according to claim 1,
wherein the plurality of routes include
at least one of a sub route that is a reserve route and an escape route that allows the user to escape from a main route that is a primary route, and the main route.

4. The electronic apparatus according to claim 3,
wherein the sub route is a route having a first point on the main route as a start point and a second point on the main route as a goal point.

5. The electronic apparatus according to claim 3,
wherein the escape route is a route having any of points on the main route as a start point and a point that is not on the main route as a goal point.

6. The electronic apparatus according to claim 1,
wherein the display processor displays the plurality of routes in different line colors or line types in accordance with the intended uses of the plurality of routes.

7. The electronic apparatus according to claim 1,
wherein the display processor further displays a route being selected by the user and routes not being selected by the user in display aspects different from one another.

8. The electronic apparatus according to claim 1,
wherein the display processor further displays a route having been followed by the user and a route not having been followed by the user in display aspects different from each other.

9. The electronic apparatus according to claim 1,
wherein the electronic apparatus is a portable electronic apparatus and attachable to a predetermined site of the user.

10. The electronic apparatus according to claim 9,
wherein the predetermined site is an arm or a wrist.

11. A display processing method executed by a computer of an electronic apparatus, the method comprising
displaying a plurality of routes intended uses of which are specified by a user in different display aspects on a display in accordance with the intended uses of the plurality of routes.
